(19) United States
(12) Patent Application Publication
(10) Pub. No.: US 2018/0154936 A1
(43) Pub. Date: Jun. 7, 2018

(54) Vehicle Steering Apparatus Having Automatic Steering Function

(71) Applicant: Hitachi Automotive Systems, Ltd., Hitachinaka-shi, Ibaraki (JP)

(72) Inventors: Masaru YAMASAKI, Tokyo (JP); Tadashi SATOU, Tokyo (JP); Mitsuo SASAKI, Atsugi-shi (JP)

(21) Appl. No.: 15/737,509

(22) PCT Filed: Jun. 9, 2016
(86) PCT No.: PCT/JP2016/067154

§ 371 Date: Dec. 18, 2017

(30) Foreign Application Priority Data
Jun. 22, 2015 (JP) 2015-124360

(51) Int. Cl. B62D 15/02; B62D 6/08; B62D 5/04

(52) U.S. Cl. CPC B62D 15/025; B62D 15/0285; B62D 5/0484; B62D 6/08

(57) ABSTRACT

Provided is a method and apparatus capable of rapidly releasing an automatic steering mode and switching to a manual steering mode in which steering is performed by a driver when there is a steering input from a driver in a steering wheel, so that it is possible to prevent disturbance in a behavior of a vehicle caused by an excessive manipulation of the driver who memorizes strangeness. In the vehicle steering apparatus, a state that a driver holds the input unit of the steering input means is detected on the basis of a characteristic change caused by an increase of a mass or inertial moment in the input unit of the steering input means or a part subordinate thereto. In addition, a switching operation between the automatic steering mode and the manual steering mode is performed on the basis of a result of the holding detection.

### TECHNICAL FIELD

The present invention relates to a vehicle steering apparatus having an automatic steering function.

### BACKGROUND ART

As a background art of this technical field, there is known a technique discussed in Japanese Unexamined Patent Application Publication No. 2002-200985 (PTL 1). In this publication, a rotation angle of an output shaft changes earlier than a rotation angle of an input shaft. In addition, if a change amount of the rotation angle of the input shaft within a certain time is equal to or smaller than a predetermined value, it is determined that a driver releases hands from a steering wheel, so that an automatic steering mode is performed, in which a steering mechanism is automatically steered such that the vehicle travels along a lane of the road.

If the rotation angle of the input shaft changes earlier than the rotation angle of the output shaft in the middle of the automatic steering, it is determined that a driver operates the steering wheel, and the mode is switched to the assist mode in which the steering is assisted by driving an electric motor on the basis of the driver's steering wheel motion and applying a torque generated from the electric motor to the steering mechanism.

### CITATION LIST

### Patent Literature

PTL 1: Japanese Unexamined Patent Application Publication No. 2002-200985

### SUMMARY OF INVENTION

### Technical Problem

In PTL 1, in order to determine whether or not the mode is switched from the automatic steering mode to the manual steering mode (assist mode) in which the steering wheel is manipulated by a driver, it is necessary to input a steering torque having a magnitude, at which a change amount in rotation angles of output and input shafts is observed, to the steering wheel. Here, while the steering torque is small at an initial stage of the steering wheel manipulation, a sufficient change amount is not observed in the rotation angles of the output and input shafts. Therefore, the switching is not performed.

That is, the automatic steering mode is continuously executed even when the driver manipulates the steering wheel. For this reason, the driver may memorize strangeness and apply an excessive force. This may disturb a behavior of the vehicle. Therefore, it may be difficult to make a safe travel.

In view of the aforementioned problems, an object of the present invention is to provide a method and apparatus capable of preventing disturbance in a behavior of the vehicle caused by an excessive manipulation from a driver who memorizes strangeness by rapidly releasing the automatic steering mode and switching to the manual steering mode, in which steering is performed by the driver, in a case where there is a steering input from the driver in the steering wheel.

### Solution to Problem

In order to address the aforementioned problems, for example, the configurations described in the claims are employed. Although the invention includes a plurality of means to solve the aforementioned problems, the present invention has the following characteristics by way of example.

A vehicle steering apparatus includes: a steering input means configured to detect steering from a driver; a travel control device configured to execute a travel control; and a steering means configured to perform steering of tires of a vehicle on the basis of a steering position input to the steering input means or calculated by the travel control device, an operation being performed in a manual steering mode based on steering from a driver and an automatic steering mode based on a calculation result from the travel control device, wherein a state that a driver holds an input unit of the steering input means is detected on the basis of a characteristic change caused by an increase of a mass or an inertial moment in the input unit of the steering input means and a part subordinate thereto, and a switching operation between the automatic steering mode and the manual steering mode is performed on the basis of a result of the detection of the holding.

### Advantageous Effects of Invention

According to the present invention, it is possible to provide an apparatus capable of rapidly releasing the automatic steering and switching to the manual steering in a case where a steering input from a driver is applied to the steering wheel during the automatic steering mode control, and preventing disturbance in a behavior of the vehicle caused by an excessive manipulation from a driver who memorizes strangeness. Problems, configurations, and effects other than above are revealed with the following descriptions of the embodiment.

### BRIEF DESCRIPTION OF DRAWINGS

FIG. 1 is an exemplary schematic diagram illustrating a front wheel steering system according to this embodiment.

FIG. 2 is an exemplary internal processing block diagram of a steering controller.

FIG. 3 illustrates an exemplary flow for switching from an automatic steering mode to a manual operation mode.

FIG. 4 illustrates an exemplary frequency domain signal intensity 301 around a steering wheel when a driver does not hold the steering wheel.

FIG. 5 illustrates an exemplary frequency domain signal intensity 302 around the steering wheel when a driver holds the steering wheel.

FIG. 6 is a comparative example illustrating frequency domain signal intensities around the steering wheel when a driver holds the steering wheel and when a driver does not hold the steering wheel.

FIG. 7 illustrates an exemplary relationship between a change of the frequency domain signal intensity around the steering wheel and a bandpass filter characteristic 303.

FIG. 8 illustrates an exemplary relationship between a change of the frequency domain signal intensity around the steering wheel and a lowpass filter characteristic 304.

FIG. 9 illustrates an exemplary internal processing block diagram of a steering controller.

FIG. 10 illustrates an exemplary flow for switching from the automatic steering mode to a manual operation mode.

FIG. 11 is an exemplary diagram illustrating a change of the steering torque, a change of the steering torque threshold value, and a switching timing.

### DESCRIPTION OF EMBODIMENTS

Embodiments of the present invention will be described on the basis of examples.

### First Embodiment

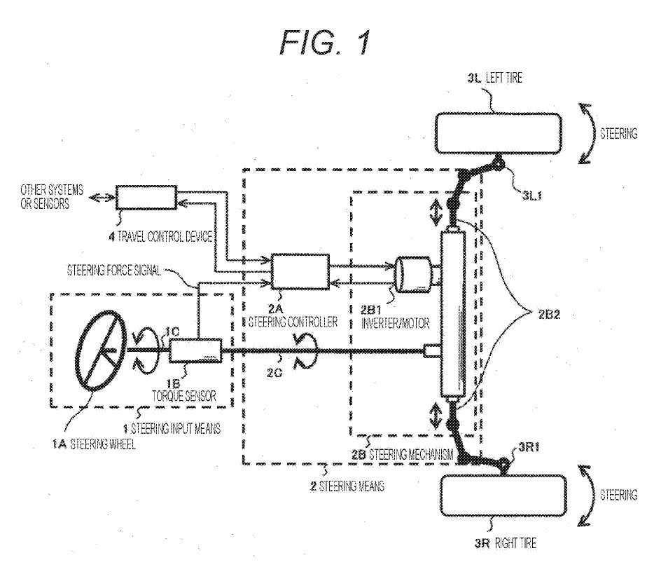

In this embodiment, an exemplary front wheel steering system of a passenger car will be described with reference to FIGS. 1 to 8.

FIG. 1 is an exemplary schematic diagram illustrating a front wheel steering system according to this embodiment.

The front wheel steering system has a steering input means 1, a steering means 2, a left knuckle 3L1, a right knuckle 3R1, a left tire 3L, a right tire 3R, and a travel control device 4. The steering input means 1 consists of a steering wheel 1A freely rotatably installed in a chassis of a vehicle, a torque sensor 1B, and a connecting shaft 1C. The steering means 2 consists of a steering controller 2A, a steering mechanism 2B, and a lower connecting shaft 2C. In addition, the steering mechanism 2B has an inverter/motor 2B1, and an output unit of the steering mechanism is a rack end 2B2.

The front wheel steering system performs both a steering operation based on a driver's steering manipulation (manual steering mode) and a steering operation (automatic steering mode) based on a command from a travel control device.

In the case of the manual steering mode, the steering input means transmits a driver's steering rotational motion received from the steering wheel 1A to the connecting shaft, the torque sensor, and the lower connecting shaft and delivers it to the steering mechanism 2B of the steering means 2. In addition, the torque sensor detects a steering torque and outputs it as a steering force signal. The steering means 2 converts a steering rotational motion input to the steering mechanism 2B into a translational motion of the rack end 2B2 using an internal rack-and-pinion mechanism (not shown) and outputs the translational motion. The right knuckle 3R1 and the left knuckle 3L1 are freely rotatably installed in a chassis of the vehicle and are rotated by receiving the translational motion of the rack end. Since the right tire 3R and the left tire 3L are installed in the right and left knuckles, respectively, each of the tires is steered by the rotation of the knuckle to make a steering operation.

The steering controller 2A receives a steering force signal (steering torque value) from the torque sensor 1B. In the manual steering mode, the front wheel steering system makes an operation for assisting a driver's steering motion using a torque of an electric motor. Therefore, the steering controller calculates a suitable motor torque on the basis of the steering force signal and a vehicle travel speed and outputs it as a target steering force.

The inverter/motor 2B1 receives the target steering force and generates and outputs the motor torque by adjusting a voltage applied to the electric motor to obtain a steering force having a magnitude equal to that of the target steering force. The steering mechanism 2B receives the motor torque, converts it into the translational force to the rack end using an internal ball screw mechanism (not shown), and obtains and outputs the translational motion of the rack end as the translational force.

That is, the translational motion of the rack end includes a torque sum including both the steering torque from a driver and the motor torque. Therefore, the driver's steering motion is assisted by the motor.

In the automatic steering mode, it is assumed that a driver does not hold the steering wheel, and there is no rotation input to the steering wheel unlike the manual steering mode. The travel control device 4 receives information from other systems or sensors (not shown) and determines and outputs steering (target steering angle) necessary to allow the vehicle to make a desired travel. In the automatic steering mode, since the front wheel steering system performs an adjustment operation for matching an actual steering angle with the target steering angle, the steering controller receives the target steering angle, the actual steering angle, the vehicle travel speed, and the like, calculates the motor torque such that there is no difference between the target steering angle and the actual steering angle, and outputs it as a target steering force.

The inverter/motor receives the target steering force and generates and outputs the motor torque in a similar way to the case of the manual steering mode. The steering mechanism 2B receives the motor torque, converts the motor torque into a translational force in the rack end direction by an internal ball screw mechanism (not shown), and obtains and outputs the translational motion of the rack end as the translational force. In the following description, similar to the manual steering mode, it is assumed that the right and left knuckles 3R1 and 3L1 are rotated, and the right and left tires 3R and 3L are steered, so that the steering angles (actual steering angle) of the tires are adjusted to match angles necessary in a vehicle travel scheduled by the travel control device to perform an automatic steering operation.

Here, in a case where a driver requests to release the automatic steering in the middle of the automatic steering operation, a driver wants to obtain a desired vehicle motion by rotating the steering wheel in some cases. Therefore, in a case where an input is applied to the steering wheel in the middle of the automatic steering operation, the front wheel steering system is necessary to have a function of stopping the automatic steering mode and advancing to the manual steering mode.

In a method for detecting an input to the steering wheel in the related art, it is necessary to input a steering torque having a magnitude, at which a change amount in the rotational angles of the output shaft and the input shaft is observed, to the steering wheel. Therefore, while the steering torque is small at an initial stage of the steering wheel operation, the change amount in the rotational angles of the output and input shafts does not reach a state at which a sufficient change amount is observed. Therefore, the switching is not performed.

That is, the automatic steering mode is continuously performed even when a driver manipulates the steering wheel.

Therefore, time is taken until the automatic steering is released in response to a driver's steering motion. For this reason, the driver memorizes resistance (strangeness) in the steering wheel manipulation and sometimes operates the steering wheel with a stronger force due to the resistance in some cases. Therefore, the driver may excessively manipulate the steering wheel with a force remaining after the automatic steering operation is released. As a result, a behavior of the vehicle may be disturbed in some cases.

In this embodiment, as a method for detecting an input to the steering wheel, a process of detecting whether or not a driver holds the steering wheel is executed by the steering controller. As a driver holds the steering wheel, it is detected that there is an input to the steering wheel, so that the automatic steering mode stops, and the mode advances to the manual steering mode.

As a result, the mode can advance to the manual steering mode as a driver holds the steering wheel. Therefore, time is not taken until the automatic steering is released in response to the driver's steering motion. In addition, a driver does not memorize resistance (strangeness) in the steering wheel manipulation. Therefore, the driver does not excessively manipulate the steering wheel. As a result, it is possible to prevent disturbance in a behavior of the vehicle.

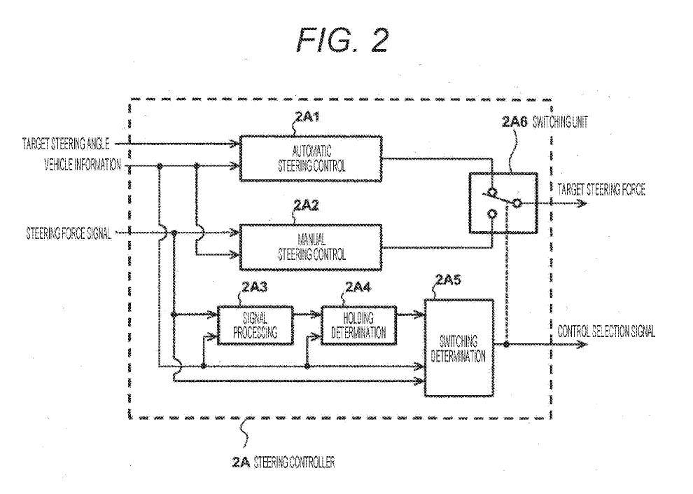

FIG. 2 is an exemplary internal processing block diagram of the steering controller.

The steering controller receives a target steering angle generated from the travel control device, vehicle information including a vehicle travel speed, a motor rotation angle, control mode switching information, steering wheel rotation angle information, and the like, and a steering force signal from the torque sensor, and outputs a control selection signal representing the target steering force and the control mode switching state.

An automatic steering control unit 2A1 receives the target steering angle and the vehicle information, calculates a motor torque by which a difference between the target steering angle and the actual steering angle is removed, and outputs the motor torque as the target steering force. A manual steering control unit 2A2 receives the steering force signal and the vehicle information, calculates a motor torque suitable to assist the driver's steering, and outputs it as the target steering force.

A signal processing unit 2A3 receives the steering force signal, extracts a predetermined frequency domain signal, for example, using a bandpass filter, and outputs an intensity of the extracted signal as a characteristic amount.

A holding determination unit 2A4 receives the characteristic amount as an intensity of the signal passing through the bandpass filter and determines that a driver holds the steering wheel, for example, in a case where a state that the characteristic amount is equal to or larger than a predetermined holding determination threshold value is continuously maintained for a predetermined time or longer. Then, the holding determination unit 2A4 outputs the holding determination.

The switching determination unit 2A5 receives the holding determination, the steering force signal, and the vehicle information, determines which one of the automatic steering control and the manual steering control is executed finally, and outputs the result as a control selection signal.

The switching unit 2A6 receives a target steering force based on the automatic steering control, a target steering force based on the manual steering control, and the control selection signal and outputs a signal of the steering control unit selected by the control selection signal as a target steering force.

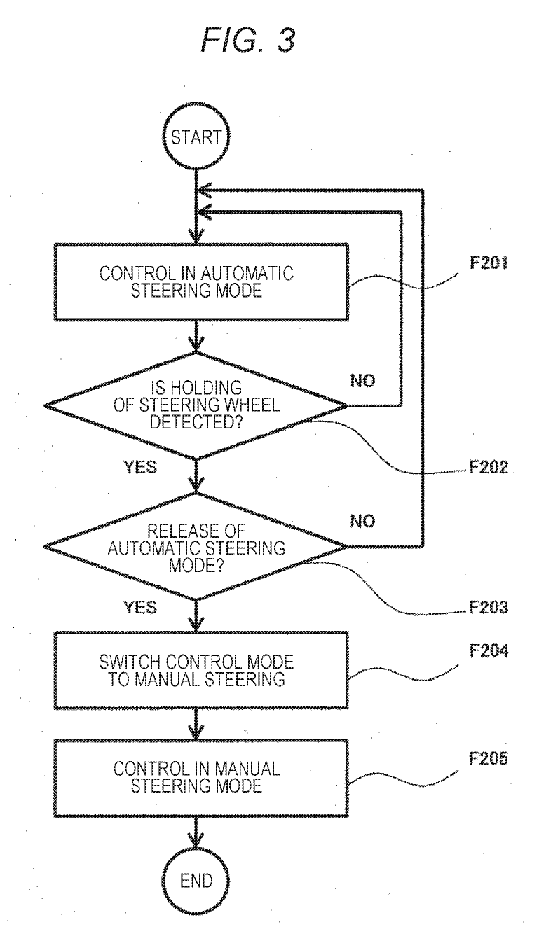

FIG. 3 is an exemplary flow for switching from the automatic steering mode to the manual operation mode.

An operation for stopping the automatic steering mode and advancing to the manual steering mode in a case where an input is applied to the steering wheel according to this embodiment will be described.

In an automatic steering mode control flow F201, the switching determination unit 2A5 is designated to perform the automatic steering control based on the control mode switching information from the travel control device included in the vehicle information to allow the output control selection signal to be selected as the automatic steering control. Therefore, the switching unit 2A6 selects the target steering force resulting from the automatic steering control unit. Therefore, the steering controller outputs the target steering force calculated by the automatic steering control unit.

Then, in a steering wheel holding detection flow F202, the processing of the signal processing unit 2A3 and the holding determination unit 2A4 are executed.

The signal processing unit receives the steering force signal and transmits it to the bandpass filter. Here, a pass frequency range of the bandpass filter does not substantially include a resonant frequency around the steering wheel and is set to a frequency substantially lower than the resonant frequency.

That is, the steering wheel is slightly vibrated by receiving a vehicle vibration, a force such as a reactive force from the tires, or the like, and this vibration is observed in the steering force signal. When an inertial moment around the steering wheel increases as a driver holds the steering wheel, the resonant frequency around the steering wheel decreases on the basis of the principle of physics.

Then, a peak resonance frequency moves to the passband of the bandpass filter. Therefore, a characteristic amount which is the intensity of the signal passing through the bandpass filter is small when a driver does not hold the steering wheel, but is large when a driver holds the steering wheel. That is, the output of the signal processing unit becomes a strong intensity signal when a driver holds the steering wheel.

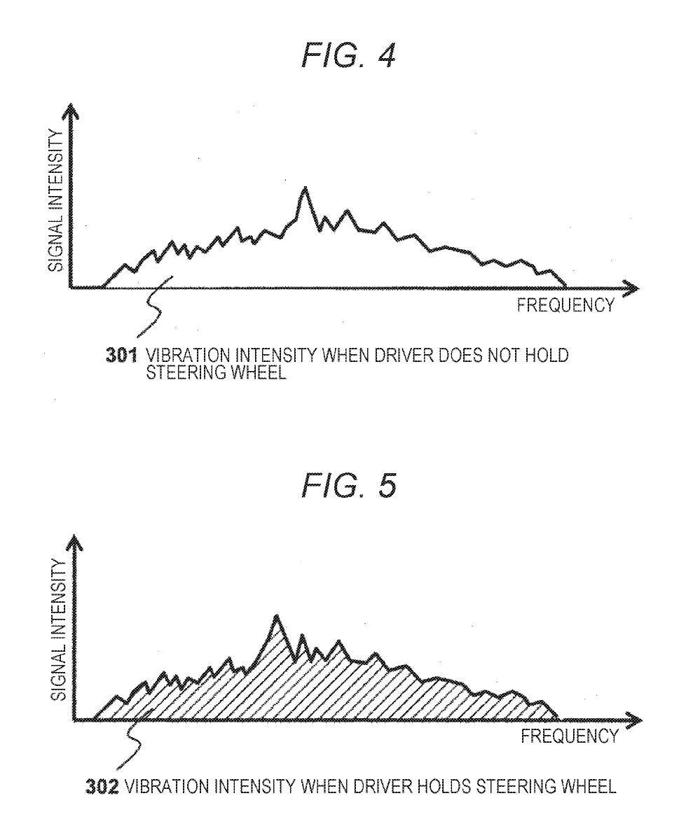

FIG. 4 illustrates an exemplary frequency domain signal intensity 301 around the steering wheel when a driver does not hold the steering wheel.

FIG. 5 is an exemplary frequency domain signal intensity 302 around the steering wheel when a driver holds the steering wheel.

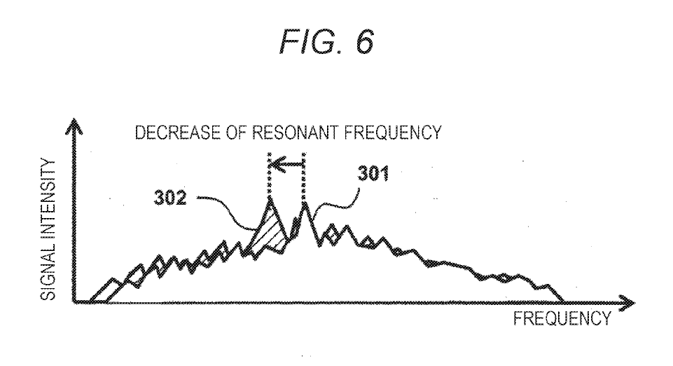

FIG. 6 illustrates a comparison example of the frequency domain signal intensities around the steering wheel when a driver holds the steering wheel and when a driver does not hold the steering wheel.

As illustrated in the examples of FIGS. 4, 5, and 6, a vibration characteristic is changed depending on a steering wheel holding state of a driver. The resonant frequency indicating a high vibration characteristic remarkably decreases as a driver holds the steering wheel.

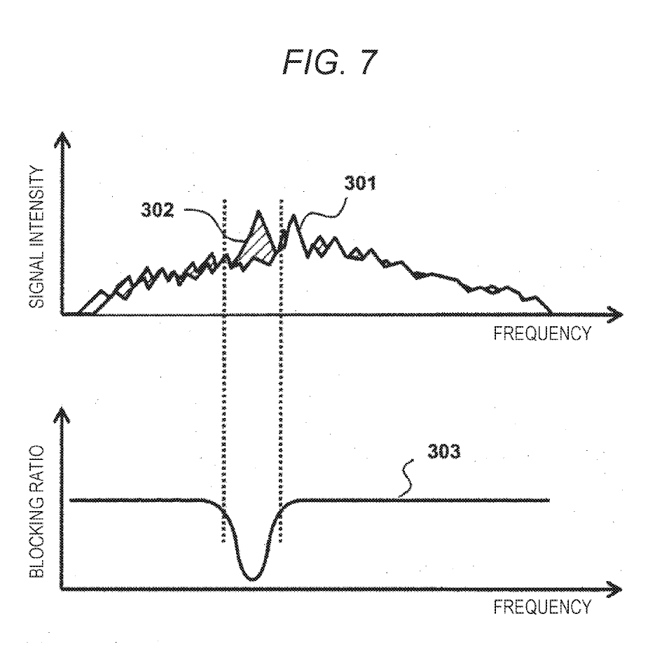

FIG. 7 illustrates an exemplary relationship between a change of the frequency domain signal intensity around the steering wheel and a pass frequency characteristic 303 of the bandpass filter that does not substantially include the resonant frequency, but is set to a frequency substantially lower than the resonant frequency.

Subsequently, the holding determination unit receives the characteristic amount which is the intensity of the signal passing through the bandpass filter. If a state in which the characteristic amount is equal to or larger than the holding determination threshold value set in advance is continuously maintained for a predetermined time or longer, it is determined that a driver holds the steering wheel, and the holding determination is output as “YES.” If the characteristic amount is equal to or smaller than the threshold value, the holding determination is output as “NO.”

When a driver does not hold the steering wheel, the holding determination becomes “NO,” and the process returns to the control flow F201 in the automatic steering mode, so that the automatic steering is continuously executed.

When a driver holds the steering wheel, the holding determination becomes “YES,” and the process advances to an automatic steering release check flow F203.

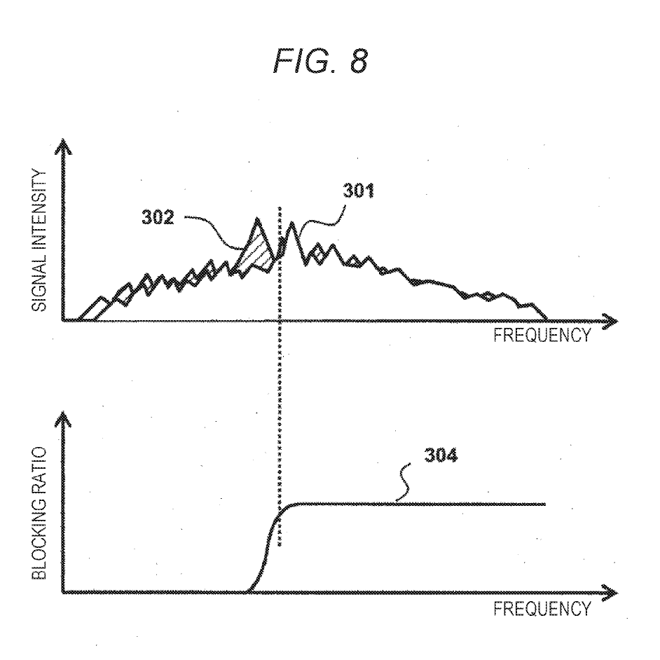

Note that the signal processing unit 2A3 may include a lowpass filter in which a low frequency vibration is allowed to pass (FIG. 8) because the resonant frequency around the steering wheel decreases as a driver holds the steering wheel, and it is desirable to detect a movement of the peak toward the low frequency side.

Note that, since the resonant frequency around the steering wheel decreases as a driver holds the steering wheel, the signal processing unit 2A3 performs a process of calculating the frequency characteristic of the steering force signal by executing, for example, a fast Fourier transform. The holding determination unit 2A4 may extract a vibration intensity of a predetermined frequency by which a change of the resonant frequency can be recognized or may set it as the characteristic amount. Alternatively, the holding determination unit 2A4 may obtain a change of the vibration number at a resonance peak frequency on the basis of the result of the Fourier transform and set it as the characteristic amount.

Note that the signal processing unit 2A3 receives the steering force signal, performs calculation for estimating, for example, an inertial moment or a mass around the steering wheel, and outputs the calculated inertial moment or mass as the characteristic amount. The holding determination unit 2A4 may receive the characteristic amount, determine that a driver holds the steering wheel, for example, when a state that the characteristic amount is equal to or larger than the holding determination threshold value set in advance is continuously maintained for a predetermined time, and output the holding determination.

Note that, since the characteristic of resonance around the steering wheel varies depending on a change of the vehicle state or the driver state, a characteristic parameter of the bandpass filter or the lowpass filter of the signal processing unit 2A3, a predetermined frequency for evaluating a result of the Fourier transform, or the like may be automatically adjusted by a learning function using vehicle travel history data or may be adjusted depending on driver's characteristics, such as physical status, gender, or age. Alternatively, they may be automatically adjusted by determining the physical status of the driver on the basis of a weight sensor provided on a seat or a seat belt pulling length.

A characteristic amount for detecting whether or not a driver holds the steering wheel is observed in an amplified manner by automatically adjusting the characteristic parameter of the filter, a predetermined frequency used to evaluate a result of the Fourier transform, or the like depending on a change of the vehicle state or the driver state. Therefore, it is possible to more reliably perform the holding determination.

In the automatic steering release check flow F203, the processing of the switching determination unit 2A5 is executed.

The switching determination unit receives the holding determination, the steering force signal, and the vehicle information, determines which one of the automatic steering control and the manual steering control is executed, and outputs the control selection signal. For example, in a case where switching to the manual steering control is prohibited by the signal from the travel control device contained in the vehicle information even when the holding determination is set to YES, it is determined that the automatic steering control is continuously performed. In addition, the selection signal is selected as the automatic steering control.

As a result, the steering control selection is performed comprehensively on the basis of the vehicle status as well as the holding determination. Therefore, it is possible to select a most suitable control mode.

Here, in a case where it is not allowed to release the automatic steering mode, the process returns to the automatic steering mode control flow F201, and the automatic steering is continuously performed. In a case where it is allowed to release the automatic steering mode, the process advances to a control mode manual switching flow F204.

In the control mode switching flow F204, the processing of the switching unit 2A6 is executed. The switching unit receives the target steering force based on the automatic steering control, the target steering force based on the manual steering control, and the control selection signal and outputs the signal of the steering control unit selected by the control selection signal as the target steering force. Here, in a case where the selection signal is changed from the automatic steering control selection to the manual steering control selection, the control mode is changed, and the switching is performed to output the target steering force from the manual steering control unit. After the switching, the process advances to a manual steering mode control flow F205.

Note that the switching change process in the control mode switching flow F204 may be performed, for example, for one control cycle of the steering controller, or may be slowly performed across several tens or several thousands of cycles.

Note that the switching change process of the control mode switching flow F204 may be performed such that, for example, in a case where a reactive force input from the vehicle side to the steering wheel is small, such as during a straight travel, the switching is performed within a relatively short time. In a case where the reactive force input from the vehicle side to the steering wheel is larger, such as during the turning, the switching change process may be performed for a relatively long time.

Note that the switching change process of the control mode switching flow F204 may be performed, for example, such that the target steering force based on the automatic steering control and the target steering force based on the manual steering control are mixedly output during the switching.

Note that the switching change process of the control mode switching flow F204 may be performed, for example, such that, in a case where the target steering force based on the automatic steering control and target steering force based on the manual steering control are mixedly output, the mixing ratio is slowly changed during the switching.

In the manual steering mode control flow F205, the switching unit 2A6 selects the target steering force generated from the manual steering control unit, and the steering controller outputs the target steering force calculated by the manual steering control unit.

In this manner, by determining the steering input from a driver during the automatic steering mode control as detection of holding of the steering wheel of the driver, the front wheel steering system of the passenger car according to an embodiment of the invention can start the automatic steering release process while the steering torque at the initial stage of the steering wheel manipulation is small. Therefore, time is not taken until the automatic steering is released in response to a driver's steering motion. Accordingly, it is possible to preventing disturbance in a behavior of the vehicle caused by an excessive manipulation from a driver who memorizes strangeness by rapidly releasing the automatic steering mode and switching to the manual steering mode in which steering is performed by a driver.

Note that, although the steering torque value measured by the torque sensor is employed in this embodiment, a value of the rotation angle information of the steering wheel may also be employed. Alternatively, a value of the rotation angle sensor installed in the motor may also be employed. Furthermore, these values may also be combined. If the value of the rotation angle information of the steering wheel or the value of the rotation angle sensor installed in the motor is employed, it is possible to execute the control of this embodiment even when the torque sensor is failed.

Note that batteries as a power source or feeding lines are not illustrated in the drawings. In addition, sensors or wirings for detecting a vehicle travel speed or a motor rotor position are not illustrated in the drawings.

Note that, although a vibration of the steering wheel generated by receiving a vehicle vibration, a reactive force from the tire, and the like is observed in this embodiment, the vibration may be intentionally generated by driving a vibration generator of the motor or the steering wheel or a reactive force generator of the steering wheel to observe a resulting vibration of the steering wheel. As a result, the characteristic amount for detecting holding of the steering wheel is observed in an amplified manner by intentionally generating the vibration. Therefore, it is possible to more reliably perform the holding determination.

Note that, although the steering wheel is employed as a steering input means, any type of controllers such as a joystick or a lever may also be employed as long as it can be gripped by a driver.

Note that, although the steering apparatus is configured to input the rotation of the steering wheel to the steering mechanism of the steering means, a steer-by-wire configuration may also be employed, in which the torque of the electric motor is controlled on the basis of the steering torque detected by the torque sensor without mechanically connecting the steering wheel and the steering mechanism, and the steering is performed only on the basis of the electric motor torque.

Note that, although the switching to the manual operation mode is determined on the basis of the internal signal of the steering system such as the steering torque in this embodiment, the switching to the manual operation mode may also be determined by referring to a signal from other systems such as a brake system control input.

In order to check whether or not the release function of the automatic steering is normally operated in the front wheel steering system according to this embodiment, the release timings are compared between a case where a rotational torque is applied to the steering wheel using a spring or the like and a case where a mass is loaded on the steering wheel, and a rotational torque is then applied using a spring or the like. It may be possible to determine that the release function is normally operated if the release time is shorter in a case where a mass is loaded on the steering wheel, and a rotational torque is then applied using a spring or the like.

As described above, according to this embodiment, even in a case where the release of the automatic steering is requested from a driver to the vehicle steering apparatus having an automatic steering function by rotating the steering wheel in the middle of the automatic steering operation, it is possible to provide an apparatus capable of rapidly releasing the automatic steering and switching to the manual steering, and preventing disturbance in a behavior of the vehicle caused by an excessive manipulation from a driver who memorizes strangeness.

### Second Embodiment

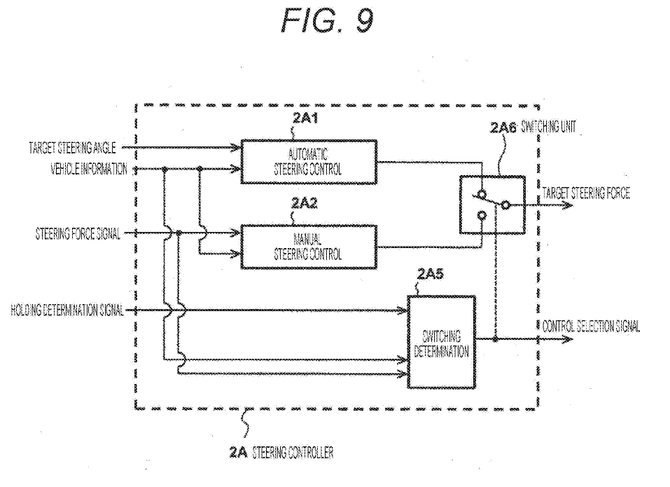

An exemplary front wheel steering system of a passenger car according to a second embodiment of the invention will now be described with reference to FIGS. 9 to 11.

Like reference numerals denote like elements as in the first embodiment, and they will not be described repeatedly. First, configurations of characteristic parts of the second embodiment will be described.

FIG. 9 is an exemplary internal processing block diagram of a steering controller.

The steering controller receives the target steering angle generated by the travel control device, the vehicle information such as the vehicle travel speed, the motor rotation angle, the control mode switching information, or the steering wheel rotation angle information, the steering force signal generated from the torque sensor, and the holding determination signal and outputs the target steering force and the control selection signal representing the control mode switching state.

The automatic steering control unit 2A1 receives the target steering angle and the vehicle information, calculates a motor torque by which a difference between the target steering angle and the actual steering angle is removed, and outputs the motor torque as a target steering force. The manual steering control unit 2A2 receives the steering force signal and the vehicle information, calculates a motor torque suitable to assist steering of a driver, and outputs the motor torque as a target steering force.

The switching determination unit 2A5 receives the holding determination, the steering force signal, and the vehicle information, determines which one of the automatic steering control and the manual steering control is finally executed, and outputs the determination result as a control selection signal.

The switching unit 2A6 receives the target steering force based on the automatic steering control, the target steering force based on the manual steering control, and the control selection signal, and outputs a signal of the steering control unit selected by the control selection signal as a target steering force.

Note that, although the holding determination signal is supplied from the outside here, the invention is not limited thereto. Alternatively, the holding determination signal may be calculated internally by the steering controller.

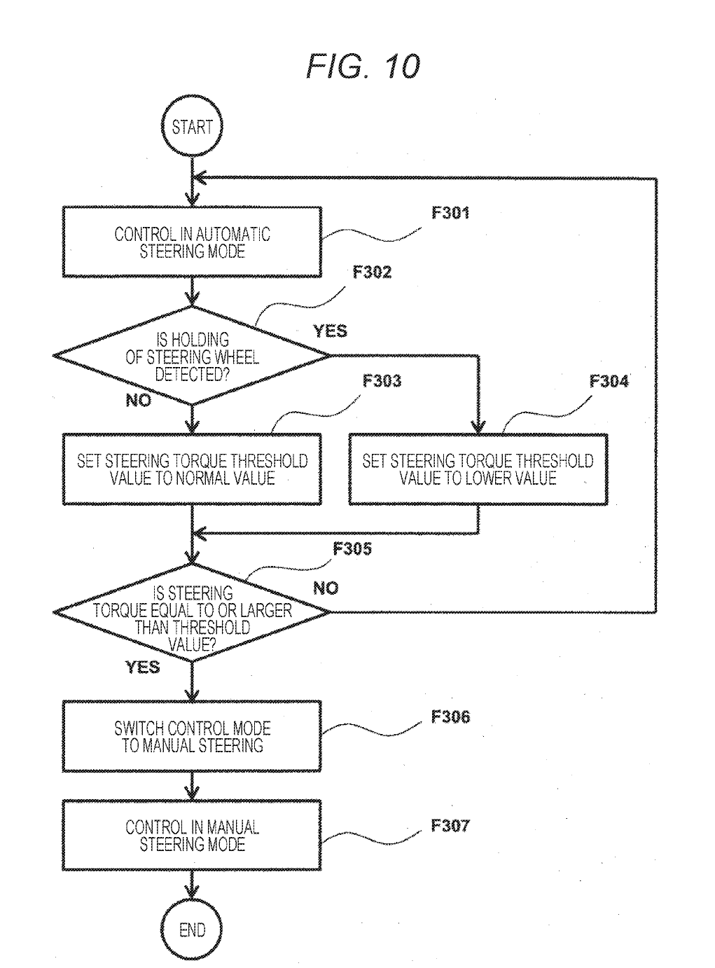

FIG. 10 illustrates an exemplary flow for switching from the automatic steering mode to the manual operation mode.

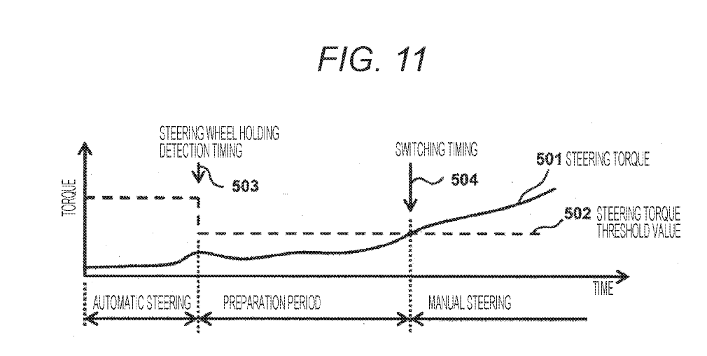

FIG. 11 is an exemplary schematic diagram illustrating changes of the steering torque and the steering torque threshold value generated by the steering force signal and the switching timing in the switching from the automatic steering mode to the manual operation mode according to this embodiment. Note that the abscissa of FIG. 11 refers to time, and the ordinate refers to a torque value.

An operation for stopping the automatic steering mode and advancing to the manual steering mode when an input is applied to the steering wheel according to this embodiment will be described.

In an automatic steering mode control flow F301, the switching determination unit 2A5 outputs the control selection signal set to the automatic steering control because the control mode switching information from the travel control device contained in the vehicle information designates the automatic steering control. Therefore, the switching unit 2A6 selects the target steering force generated from the automatic steering control unit. Therefore, the steering controller outputs the target steering force calculated by the automatic steering control unit (automatic steering period in FIG. 11)

Then, from a steering wheel holding determination flow F302, the processing of the switching determination unit 2A5 is executed. The switching determination unit receives the holding determination and sets the steering torque threshold value serving as a condition for switching from the automatic steering mode to the manual steering mode. That is, if it is determined that a driver does not hold the steering wheel, a normal value (sufficiently large value to prevent erroneous switching from the automatic steering mode to the manual steering mode) is set as the steering torque threshold value (F303). Otherwise, if it is determined that a driver holds the steering wheel, a lower value is set as the steering torque threshold value (F304).

In a steering torque determination flow F305, it is determined whether or not the steering torque exceeds the threshold value set in the previous flow by referring to the steering force signal input to the switching determination unit 2A5. For example, in a case where a state that the steering torque based on the steering force signal is equal to or higher than the steering torque threshold value is continuously maintained for a predetermined time or longer, it is determined that the steering torque exceeds the threshold value.

Here, in a case where it is detected that a driver holds the steering wheel during the automatic steering mode, the steering torque threshold value 502 is lowered through the aforementioned processing as indicated by the steering wheel holding detection timing 503 of FIG. 11. Here, as a driver starts to input a steering torque to the steering wheel, the steering torque 501 increases and exceeds the steering torque threshold value at the switching timing 504 as illustrated in FIG. 11. In this manner, since the steering torque threshold value 502 is lowered, the switching timing comes within a short time from the start of the input of the steering torque from the driver to the steering wheel, so that it is possible to advance to the manual steering mode.

In a control mode switching flow F206, the processing of the switching unit 2A6 is executed. The switching unit receives the target steering force based on the automatic steering control, the target steering force based on the manual steering control, and the control selection signal and outputs a signal of the steering control unit selected by the control selection signal as a target steering force. Here, in a case where the selection signal is changed from the automatic steering control selection to the manual steering control selection, a change process is performed, and switching is performed such that the target steering force based on the manual steering control is finally output. After the switching, the process advances to a manual steering mode control flow F307.

In the manual steering mode control flow F307, the switching determination unit 2A5 sets the aforementioned calculation result and the output control selection signal as selection of the manual steering control. Therefore, the switching unit 2A6 selects the target steering force generated from the manual steering control unit. Therefore, the steering controller outputs the target steering force calculated by the manual steering control unit.

In this manner, in the front wheel steering system of the passenger car according to the second embodiment of the invention, a preparation period is provided on the basis of detection of holding of the steering wheel by a driver during the automatic steering mode control. In addition, since the threshold value for determining switching to the manual steering is lowered, time is not taken until the automatic steering is released in response to a driver's steering motion. Therefore, it is possible to rapidly release the automatic steering mode and switch to the manual steering mode by a driver. In addition, it is possible to prevent disturbance in a behavior of the vehicle caused by excessive manipulation from a driver who memorizes strangeness.

During the preparation period, a vibration may be intentionally generated by driving a vibration generator of the motor or the steering wheel or a reactive force generator of the steering wheel using the driver steering controller, and the resulting vibration of the steering wheel may be observed to switch the steering mode from the automatic steering mode to the manual control mode. If the vibration is intentionally generated, the characteristic amount used in determination is observed in an amplified manner. Therefore, it is possible to more reliably perform the determination.

During the preparation period, a vibration may be intentionally generated by driving a vibration generator of the motor or the steering wheel or a reactive force generator of the steering wheel using the driver steering controller, and the resulting vibration of the steering wheel may be observed to switch the mode from the automatic steering mode to the manual control mode when an amplitude of the vibration is smaller than a predetermined threshold value. By intentionally generating the vibration, the amplitude capable of facilitating measurement is employed as the characteristic amount used in the determination. Therefore, it is possible to more reliably perform the determination. Note that the vibration of the steering wheel may be a vibration of the torque in the steering wheel rotation direction, an amplitude of a displacement angle, a vibration of the force in the steering wheel shaft direction, or an amplitude of the displacement.

As described above, according to this embodiment, using the vehicle steering apparatus having the automatic steering function it is possible to rapidly release the automatic steering and switch to the manual steering even when a driver requests to release the automatic steering by rotating the steering wheel during the automatic steering driving.

Therefore, it is possible to provide an apparatus capable of preventing disturbance in a behavior of the vehicle caused by an excessive manipulation from a driver who memorizes strangeness.

It should be noted that the present invention is not limited to the aforementioned embodiments, but includes various modifications. For example, while the embodiments have been described in detail in order to explain the present invention in an easy-to-understand manner, they are not necessarily limited to those having all the configurations described above. In addition, a part of the configuration of any embodiment may be replaced with that of other embodiments, and a configuration of any embodiment may be added to the configurations of other embodiments. Furthermore, any addition, deletion, or substitution may be possible for a part of the configuration of each embodiment.

Each of the configurations, functions, processing units, processing means, and the like described above may be realized by hardware, for example, by designing a part or all of them with an integrated circuit. In addition, each of the configurations, functions, and the like described above may be realized by software, for example, by interpreting and executing a program that the processor realizes each function. Furthermore, control lines and information lines indicate what is considered necessary for the explanation, and all the control lines and the information lines are not necessarily illustrated for products. It may be considered that nearly all of the configurations are connected to each other in practice.

### REFERENCE SIGNS LIST

1 steering input means
1A steering wheel
1B torque sensor
2 steering means
2A steering controller
2B steering mechanism
2B1 inverter/motor
2B2 rack end
3L left tire
3L1 left knuckle
3R right tire
3R1 right knuckle
4 travel control device
301 signal intensity in frequency domain around steering wheel when driver does not hold steering wheel
302 signal intensity in frequency domain around steering wheel when driver holds steering wheel
303 blocking characteristic of bandpass filter
304 blocking characteristic of lowpass filter

1. A vehicle steering apparatus comprising:
a steering input means configured to detect steering from a driver;
a travel control device configured to execute a travel control; and
a steering means configured to perform steering of tires of a vehicle on the basis of a steering position input to the steering input means or calculated by the travel control device,
an operation being performed in a manual steering mode based on steering from a driver and an automatic steering mode based on a calculation result from the travel control device,
wherein a state that a driver holds an input unit of the steering input means is detected on the basis of a characteristic change caused by an increase of a mass or an inertial moment in the input unit of the steering input means and a part subordinate thereto, and
a switching operation between the automatic steering mode and the manual steering mode is performed on the basis of a result of the detection of the holding.

2. The vehicle steering apparatus according to claim 1, wherein the characteristic change is a change by which frequency domain vibration characteristics of the input unit of the steering input means and a part subordinate thereto are shifted to a lower frequency direction.

3. The vehicle steering apparatus according to claim 1, wherein the characteristic change is a change by which a frequency domain vibration characteristic of output data of a steering torque sensor is shifted to a lower frequency direction.

4. The vehicle steering apparatus according to claim 1, wherein the characteristic change is an intensity change obtained by passing motion data of the input unit of the steering input means and a part subordinate thereto through a filter capable of passing a particular frequency range.

5. The vehicle steering apparatus according to claim 1, wherein the characteristic change is an intensity change obtained by passing motion data of the input unit of the steering input means and a part subordinate thereto through a filter capable of passing a particular frequency range, and
a parameter that determines a filter characteristic is adjusted depending on a driver.

6. The vehicle steering apparatus according to claim 1, wherein the characteristic change is an intensity change obtained by passing motion data of the input unit of the steering input means and a part subordinate thereto through a filter capable of passing a particular frequency range, and
a parameter that determines a filter characteristic is automatically adjusted depending on a driver.

7. The vehicle steering apparatus according to claim 1, wherein the characteristic change is an intensity change obtained by passing motion data of the input unit of the steering input means and a part subordinate thereto through a filter capable of passing a particular frequency range, and
a parameter that determines a filter characteristic is automatically adjusted by determining a driver's physical status on the basis of a weight sensor provided in a seat or a seat belt pulling length.

8. The vehicle steering apparatus according to claim 1, wherein the characteristic change is a change of an estimated mass of a movable part obtained by calculation using a physical model from motion data of the input unit of the steering input means and a part subordinate thereto.

9. The vehicle steering apparatus according to claim 1, wherein the characteristic change is detected using a method based on a frequency domain vibration characteristic of output data of the steering torque sensor or a method based on a frequency domain vibration characteristic of rotational position information of a steering wheel, and
a control of the switching operation is continuously performed using one of the methods when a failure occurs in the other method.

10. The vehicle steering apparatus according to claim 1, wherein a switching operation between the automatic steering mode and the manual steering mode performed on the basis of a detection result regarding whether or not a driver holds the input unit of the steering input means first enters a preparation period in which a condition for switching to the manual steering mode is set to be looser than that of the automatic steering mode while automatic steering is continuously performed.

11. The vehicle steering apparatus according to claim 1, wherein a condition for switching to the manual steering mode includes a state that the steering torque exceeds a predetermined threshold value, and
a switching operation between the automatic steering mode and the manual steering mode performed on the basis of a detection result regarding whether or not a driver holds the input unit of the steering input means first enters a preparation period in which a threshold value of the steering torque for switching to the manual steering mode is set to be lower than a threshold value for switching to the manual steering mode in the case of the automatic steering mode while automatic steering is continuously performed.

12. The vehicle steering apparatus according to claim 1, wherein a switching operation between the automatic steering mode and the manual steering mode performed on the basis of a detection result regarding whether or not a driver holds the input unit of the steering input means first enters a preparation period in which a vibration generating force or a vibration generating torque is applied to the steering input means in order to facilitate detection of the characteristic change caused by an increase of a mass or an inertial moment of the input unit of the steering input means and a part subordinate thereto.

13. The vehicle steering apparatus according to claim 1, wherein, in a switching operation between the automatic steering mode and the manual steering mode performed when it is determined that a driver holds the input unit of the steering input means, the steering mode is switched to the manual steering mode immediately after the determination.

14. The vehicle steering apparatus according to claim 1, wherein a switching operation between the automatic steering mode and the manual steering mode performed when it is determined that a driver holds the input unit of the steering input means enters a preparation mode in which an automatic steering motor torque is reduced while the automatic steering is continuously performed.

15. The vehicle steering apparatus according to claim 1, wherein the vehicle is under an automatic parking control.

16. The vehicle steering apparatus according to claim 1, wherein, in a switching operation between the automatic steering mode and the manual steering mode performed when it is determined that a driver holds the steering input means, and the driver depresses a brake, the steering mode is immediately switched to the manual steering mode.

17. A vehicle steering apparatus comprising:
a steering input means configured to detect steering from a driver;
a travel control device configured to execute a travel control; and
a steering means configured to perform steering of tires of a vehicle on the basis of a steering position input to a steering input means or calculated by a travel control device,
operations being performed in a manual steering mode based on steering from a driver and an automatic steering mode based on a calculation result from the travel control device,
wherein, in a case where it is detected that a driver holds an input unit of the steering input means during the automatic steering mode, the operation enters a preparation period in which a condition for switching to the manual steering mode is set to be looser than that of the automatic steering mode while automatic steering is continuously performed.

18. The vehicle steering apparatus according to claim 17, wherein a condition for switching to the manual steering mode includes a state that the steering torque exceeds a predetermined threshold value, and
for the loose setting, a steering torque threshold value for switching to the manual steering mode is set to be lower.

19. The vehicle steering apparatus according to claim 17, wherein, during the preparation period, a vibration generating force or a vibration generating torque is applied to the steering input means in order to facilitate detection of the characteristic change caused by an increase of a mass or an inertial moment of the input unit of the steering input means and a part subordinate thereto.

20. The vehicle steering apparatus according to claim 18, wherein, during the preparation period, a condition for switching to the manual steering mode includes a state that an amplitude of the steering torque is smaller than a predetermined threshold value.
